(19) United States
(12) Patent Application Publication
(10) Pub. No.: US 2023/0192212 A1
(43) Pub. Date: Jun. 22, 2023

(54) Fixing Element for Lines on a Bicycle Component

(71) Applicant: Canyon Bicycles GmbH, Koblenz (DE)

(72) Inventor: Mario Conradt, Koblenz (DE)

(21) Appl. No.: 18/060,627

(22) Filed: Dec. 1, 2022

(30) Foreign Application Priority Data
Dec. 22, 2021 (DE) 20 2021 106 982.1

(51) Int. Cl. B62J 11/10

(52) U.S. Cl. CPC B62J 11/10

(57) ABSTRACT

A fixing element for lines, such as a brake line, on a bicycle component, in particular a steer tube, has a base body. The base body at least partly surrounds the bicycle component. A receiving element is formed, in particular integrally with the base body. The receiving element serves for receiving at least one line, in particular the brake line. For retention of the fixing element, in particular on a steer tube, retaining elements are provided which are preferably designed as cable ties.

### CROSS-REFERENCE TO RELATED APPLICATION

This application claims priority to German Patent Application No. 20 2021 106 982.1 filed Dec. 22, 2021, the disclosure of which is hereby incorporated by reference in its entirety.

### BACKGROUND OF THE DISCLOSURE

### Field of the Disclosure

The disclosure relates to a fixing element for lines on a bicycle component, in particular a steer tube.

### Description of Related Art

In modern bicycles, brake lines, shift cables, electric cables the like are often arranged within the bicycle components, i.e., on the one hand, the bicycle frame, but also the handle bar, the stem and the steer tube. For example, brake lines for a front wheel brake extend at least in part within the head tube of the bicycle frame and are guided from there into, for example, the steer tube, in order to then be guided out of the fork leg of the in the area of the brake caliper. bicycle fork In particular in the area of the head tube of the frame, and thus partly between the steer tube arranged in the head tube of the frame and the head tube, a plurality of lines such as brake lines, shift cables, Bowden cables or electrical lines are often arranged. Due to vibrations and relative movements occurring, the different lines etc. are subject to increased wear. In particular the front brake line leading to the front wheel brake, which line may for example be a Bowden cable or a hydraulic line, is moved strongly while riding. When turning the handlebar, the fork is turned and thus the brake line is twisted as well. This causes friction between the brake line and contact partners such as other lines, the steer tube, the head tube etc. Furthermore, there is a problem that extreme steering angles can cause the brake line to become clamped or wedged with other lines arranged in the head tube. This causes additional wear.

Further, inserting lines that are possibly somewhat too long, for example after the removal of spacers arranged below the handlebar stem for ergonomic adaptation of the bicycle, may cause lines to buckle within the frame. This may also cause a rubbing of the lines, primarily on the head tube.

### SUMMARY OF THE DISCLOSURE

It is an object of the disclosure, to reduce the risk of damages to lines arranged inside bicycle components.

According to the disclosure, the object is achieved by a fixing element having the feature as described herein.

The fixing element according to the disclosure serves for fixing lines such as brake lines, shift cables, Bowden cables and the like on a bicycle component. In particular, the fixing element serves for fixing a brake line which may in particular designed as a hydraulic line or a Bowden cable, which in particular is the fixing of the brake line for the front wheel brake, since the same is subjected to particular loads due the steering movement.

The fixing element according to the fixing element has a base body which at least partly surrounds a bicycle component. Specifically, the base body is designed and arranged such that is at least partly surrounds the steer tube and, in particular, is retained on the steer tube. A receiving element is connected to the base body. The receiving element serves for receiving at least one line. It is preferred that the receiving element is formed integrally with the base body. Furthermore, the fixing element comprises a retaining element for retaining the base body on the bicycle component. In a particularly preferred embodiment, the retaining element is designed or arranged such that the retaining element additionally fixes the line. Thus, in a preferred development of the disclosure, the retaining element has a double function and serves, on the one hand, for fixing the base body on the bicycle component and, on the other hand, for fixing the line. Preferably, the base body is retained on the bicycle component, which in particular is the steer tube, in particular in a clamping manner. Thus, due to the fixing element according to the disclosure, the position of a line, in particular the brake line, can be defined. This is advantageous in particular in the case of the brake line for the front wheel brake, since movements of the brake line and the associated wear are reduced thereby.

The receiving element is preferably designed such that it at least partly surrounds the at least one line. A good retention and a defined position of the at least one line are thereby obtained. It is particularly preferred that the receiving element receives exactly one line and has an at least sector-shaped cross section. Preferably, the receiving element surrounds the received line in the circumferential direction for at least 50% of the circumference, in particular at least 70% of the circumference.

The receiving element preferably extends in the longitudinal direction of the at least one line, wherein it is particularly preferred that, in the mounted state, the at least one line extends parallel to the longitudinal direction of the bicycle component, in particular the steer tube. However, it is also possible to provide a, for example, inclined or curved design of the receiving element in order to realize a defined arrangement of the line on the bicycle component.

In a particularly preferred embodiment, the base body is formed in the manner of a clamp, so that the base body surrounds the corresponding bicycle component, in particular the steer tube, in a manner similar to a clamp. Here, it is particularly preferred that the base body has a slot extending in particular in the longitudinal direction, in order to realize a clamping fastening of the clamp-like base body. It is further preferred that the base body is at least partly made of an elastically deformable material and/or comprises articulately connected parts. For example, the connection of one or a plurality of individual parts can be effected through hinges. This has the advantage that it is possible, for example, to open or bend open the base body to such an extent that the same can also be arranged laterally over the bicycle component, i.e. be arranged in particular perpendicularly to the longitudinal direction of the bicycle component on the latter, and that, as such, is not absolutely necessary to fit the base body onto the bicycle component in the longitudinal direction of the latter. In this manner, assembly is simplified.

In a particularly preferred development of the disclosure, the base body and in particular also the receiving element connected to the base body are clampingly fixed on the bicycle component by the retaining element.

In a preferred development of the disclosure, the base body has an inner contour corresponding at least partly to an outer contour of the bicycle component to which the fixing element according to the disclosure will be arranged. In particular, this is the outer contour of the steer tube. By such an in particular planar contact of the base body with the bicycle component, a secure retention can be realized.

The receiving element is preferably designed such that it has an opening in a side facing inward. The same extends in particular over the entire length of the receiving element. As such, the opening is designed similar to a slot which is closed on its outer side by that part of the receiving element in which the at least one line is arranged. As such, it is possible to realize a tapering of the inner circumference of the base body for a clamping fixation on a bicycle component in a simple manner in the area of this slit or this longitudinal opening of the receiving element. If necessary, the base body can comprise an additional slot in another area, which, in a preferred embodiment, extends substantially parallel to the opening in the receiving element.

In a particularly preferred embodiment of the disclosure, the retaining element comprises at least one, in particular at least two retaining straps. In the mounted state, these surround the base body in the circumferential direction. Here, it is further preferred that the at least one retaining strap also surrounds the receiving element which is connected to the base body and is in particular formed integrally. For an in particular simple assembly, it is preferred that the at least one retaining strap has a closure element. Thereby, the retaining strap, which is preferably elongate in the open state, can be closed in a simple manner. It is preferred that the at least one retaining strap is designed in a manner corresponding to a cable tie, in particular as a cable tie.

In order to define an exact position of the retaining element, in particular the at least one retaining strap, and to prevent slippage, it is further preferred that the at least one retaining strap is arranged in a groove, in particular a circumferential groove. The groove is preferably arranged in an outer side of the base body, possible of the receiving element. In particular, an in particular circumferential groove is provided per retaining strap.

In a preferred development, the receiving element has at least one passage opening. The same is arranged in particular in an outer side of the receiving element or forms a passage opening from the outside to the inner side of the receiving element. It is preferred that a retaining element, in particular a retaining strap is arranged in this passage opening. Thereby, a retaining element, which is in particular designed as a retaining strap and, as is particularly preferred, as a cable tie, additionally presses against the line to be fixed. Thus, the line is additionally fixed by the retaining strap and, in a preferred embodiment, is pressed against an outer side of the bicycle component, since the line is arranged in the area of the longitudinal opening of the receiving element.

In particular in the preferred embodiments, the fixing element according to the disclosure has the advantage that it is a component that is simple to mount. In particular due to the simple fastening on the steer tube, in particular by means of cable ties, a torsion-resistant and also axially slip-proof fixing of the brake line on the steer tube is realized in a simple manner. This is, in particular, a cost-effective solution, by which damage caused by a buckling of lines is also avoided.

It is particularly preferred that, due to the simple design of the base body, the same can be adapted to different components on which the fixing element is to be arranged. Especially due to the clamp-like design of the base body, the same can be arranged on steer tubes of different diameters without changing the inner contour, since, due to the slot provided, the inner diameter can easily be adapted at least within the range of a few millimeters.

It is further possible that a plurality of receiving elements are connected to the base body, which are, for example, arranged opposite each other or on different outer regions of the base body. Thus, it is possible to simultaneously fix a plurality of lines at a mutual distance, in particular on the steer shaft, using a single fixing element.

### BRIEF DESCRIPTION OF THE DRAWING

In the following, the disclosure is described in more detail by means of a preferred embodiment with reference to the accompanying drawing.

FIG. 1 shows a schematic perspective view of a preferred embodiment of the fixing element.

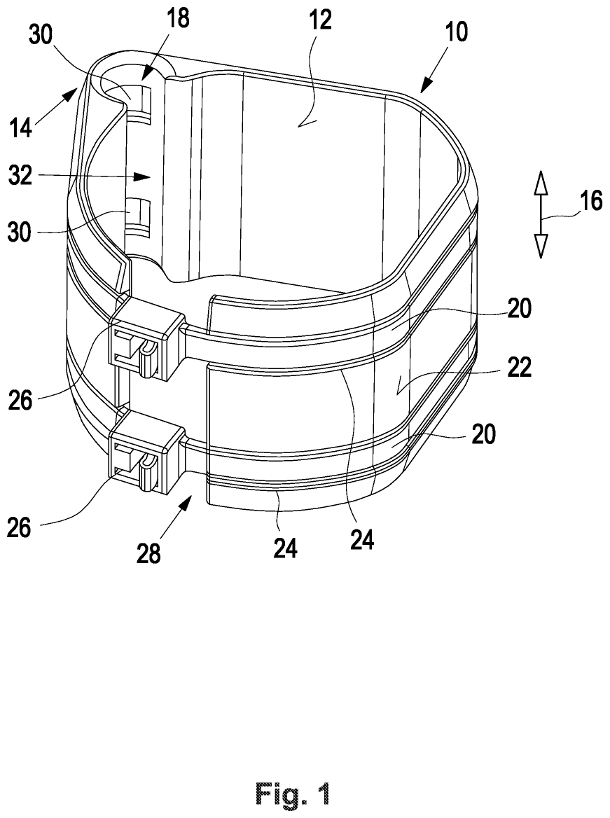

### DESCRIPTION OF THE DISCLOSURE

The fixing element has a base body 10 which in the embodiment illustrated is designed in a manner similar to a clamp and circumferentially surrounds a steer tube which is not shown. It is therefore preferred that an inner contour 12 of the base body corresponds at least in part to the outer contour of the steer tube.

In the embodiment illustrated, the base body 10 is formed integrally with a receiving element 14. The receiving element 14 extends in the longitudinal direction 16 of the base body along the entire length or height thereof. H receiving element has a substantially cylindrical opening 18 extending in the longitudinal direction 16, in which a line to be fixed, in particular a brake line, is arranged.

For the fixation of the base body together with the integrally formed receiving element 14 and thus for the fixation of a line, the fixing element has a retaining element. In the embodiment illustrated, this is realized by two cable ties 20. The two cable ties 20 surround the base body on an outer side 22 and are each arranged in a groove 24. The two cable ties 20 each comprise a locking element 26.

The base body 10 is preferably made entirely of an elastic material or elastically deformable. Thereby, it is possible to reduce the inner cross section by means of the retaining elements 24. For this purpose, the base body 10 has a slot 28 extending along the entire height in the longitudinal direction 16.

In the region of the receiving element 18, the depth of the grooves 24 is preferably designed such that passage openings 30 are formed thereby. The two cable ties 24 are arranged in the passage openings 30 and thus fix a brake line arranged in the opening 18 of the receiving element 14, if provided.

In particular for an improvement of the flexibility, the receiving element has an opening 32 in an inner side. The same extends over the entire height of the base body in the longitudinal direction 16.

1. A fixing element for lines on a bicycle component, comprising:
a base body at least partly surrounding a bicycle frame component, in particular a steer tube,
a receiving element for receiving at least one line, said element being connected to, in particular integrally formed with the base body, and
a retaining element for retaining the base body on the bicycle component and for retaining the line in the receiving element.

2. The fixing element according to claim 1, wherein the receiving element at least partly surrounds the at least one line.

3. The fixing element according to claim 2, wherein the receiving element at least partly surrounds exactly one line and has a sector-shaped cross section.

4. The fixing element according to claim 1, wherein the receiving element extends in the longitudinal direction of the at least one line.

5. The fixing element according to claim 1, wherein the base body surrounds the bicycle component in the manner of a clamp.

6. The fixing element according to claim 1, wherein the base body is elastically deformable in particular for fixing on the bicycle frame component.

7. The fixing element according to claim 1, wherein the base body can be fixed to the bicycle frame component in a clamping manner by the retaining element.

8. The fixing element according to claim 1, wherein the base body has an inner contour which at least partly corresponds to an outer contour of the bicycle frame component, in particular the steer tube.

9. The fixing element according to claim 1, wherein the receiving element has an inward directed opening extending in particular along the entire length of the receiving element.

10. The fixing element according to claim 1, wherein the retaining element has at least one, in particular two retaining straps that surround the base body in the circumferential direction.

11. The fixing element according to claim 10, wherein the at least one retaining strap has a closure element and is designed in particular as a cable tie.

12. The fixing element according to claim 10, wherein the at least one retaining strap is arranged in an in particular circumferential groove.

13. The fixing element according to claim 1, wherein the receiving element has a passage opening in which the retaining element, in particular restraining strap is arranged.
